(19) United States
(12) Patent Application Publication
(10) Pub. No.: US 2014/0095461 A1
(43) Pub. Date: Apr. 3, 2014

(54) COMMUNICATING BOOKMARKED WEBPAGE REQUESTS TO SEARCH ENGINES

(71) Applicant: MICROSOFT CORPORATION, Redmond, WA (US)

(72) Inventor: KIMBERLY JAN BURT, Bellevue, WA (US)

(73) Assignee: MICROSOFT CORPORATION, Redmond, WA (US)

(21) Appl. No.: 13/644,179

(22) Filed: Oct. 3, 2012

(51) Int. Cl. G06F 17/30

(52) U.S. Cl. 707/706; 707/E17.108

(57) ABSTRACT

Systems, methods, and computer-readable storage media are provided for informing search engines of requests for web pages bookmarked in association with a browser, and permitting such requests to be logged by the search engines as search queries. When a browser receives a request from a user for a bookmarked Uniform Resource Identifier (URI), it is determined whether the user has a search engine preference set as a default. If the user does have a default search engine, the user's request for the bookmarked URI is communicated to the default search engine, permitting the search engine to log the user's request as a search query. In parallel, the requested URI is rendered in association with the user's computing device.

### BACKGROUND

Today, users commonly create bookmarks in association with a browser for Uniform Resource Identifiers (URIs) they visit on a frequent and/or regular basis. For instance, URIs may be added as a “favorite” for a user utilizing the INTERNET EXPLORER search engine, provided by Microsoft Corporation of Redmond, Wash. When desiring to visit a bookmarked webpage, a user simply may access a list of his or her “favorites” and be navigated directly to the bookmarked URI.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In various embodiments, systems, methods, and computer-readable storage media are provided for, among other things, informing search engines of requests for web pages bookmarked in association with a browser, and permitting such requests to be logged by the search engines as search queries. Upon a browser receiving a request from a user for a bookmarked Uniform Resource Identifier (URI), it is determined whether the user has a search engine preference set as a default. If the user does indeed have a default search engine, the user's request for the bookmarked URI is communicated to the default search engine, permitting the search engine to log the user's request as a search query. In parallel (or otherwise in close time proximity), the requested URI is rendered in association with the user's computing device. In this way, search engines are able to use URIs bookmarked in association with a browser to gain knowledge regarding user webpage preferences and to utilize such shortcut navigation patterns in determining query share.

### BRIEF DESCRIPTION OF THE DRAWINGS

The present invention is illustrated by way of example and not limitation in the accompanying figures in which like reference numerals indicate similar elements and in which:

FIG. 1 is a block diagram of an exemplary computing environment suitable for use in implementing embodiments of the present invention;

FIG. 2 is a block diagram of an exemplary computing system in which embodiments of the invention may be employed;

FIG. 3 is a flow diagram showing an exemplary method for communicating requests for web pages bookmarked in association with a browser to a search engine server, in accordance with an embodiment of the present invention;

FIG. 4 is a flow diagram showing an exemplary method for logging user requests for web pages bookmarked in association with a browser as search queries, in accordance with an embodiment of the present invention; and

FIG. 5 is a flow diagram showing another exemplary method for communicating requests for web pages bookmarked in association with a browser to a search engine server, in accordance with an embodiment of the present invention.

### DETAILED DESCRIPTION

The subject matter of the present invention is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable storage media for, among other things, informing search engines of requests for web pages bookmarked in association with a browser, and permitting such requests to be logged by the search engines as search queries. Upon a browser receiving a request from a user for a bookmarked Uniform Resource Identifier (URI), it is determined whether the user has a search engine preference set as a default. If the user does have a default search engine, the user's request for the bookmarked URI is communicated to the default search engine, permitting the search engine to log the user's request as a search query. In parallel (or otherwise in close time proximity), the requested URI is rendered in association with the user's computing device.

Accordingly, one embodiment of the present invention is directed to one or more computer-readable storage media storing computer-useable instructions that, when used by one or more computing devices, cause the one or more computing devices to perform a method for communicating requests for bookmarked web pages to search engines. The method includes receiving a request from a user for a URI bookmarked in association with a browser, determining the user's default search engine is a particular search engine, and communicating the user's request to the particular search engine.

In another embodiment, the present invention is directed to one or more computer-readable storage media storing computer-useable instructions that, when used by one or more computing devices, cause the one or more computing devices to perform a method for logging requests for bookmarked web pages as search queries. The method includes receiving an indication from a browser that a particular user has requested a bookmarked URI and logging the user's request as a search query.

In yet another embodiment, the present invention is directed to a system for communicating requests for bookmarked web pages to search engines. The system includes a browser associated with one or more processors and one or more computer-readable storage media, and a data store coupled with the browser. The browser is configured to receive a request from a user for a URI bookmarked in association with a browser, determine the user's default search engine is a particular search engine, render the requested bookmarked URI and, in parallel with the rendering, communicate the user's request to the particular search engine.

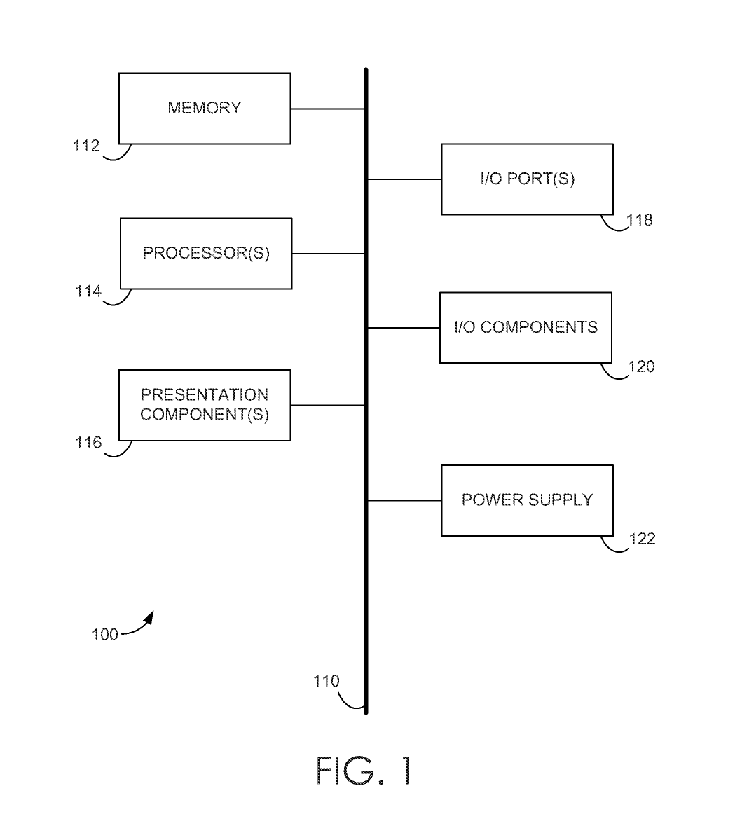

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one component nor any combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules including routines, programs, objects, components, data structures, and the like, and/or refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventor hereof recognizes that such is the nature of the art, and reiterates that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media can be any available media that can be accessed by the computing device 100 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, and the like.

As previously mentioned, users commonly create bookmarks in association with a browser for URIs they visit on a frequent and/or regular basis. When desiring to visit a bookmarked webpage, a user simply may access a list of his or her bookmarked pages and be navigated directly to a bookmarked webpage. However, these requests for bookmarked web pages bypass search engines altogether and thus represent untapped potential for data resources and query share.

Accordingly, embodiments of the present invention are generally directed to systems, methods, and computer-readable storage media for, among other things, informing search engines of requests for web pages bookmarked in association with a browser, and permitting such requests to be logged by the search engines as search queries. Upon a browser receiving a request from a user for a bookmarked URI, it is determined whether the user has a search engine preference set as a default. If the user does indeed have a default search engine, the user's request for the bookmarked URI is communicated to the default search engine, permitting the search engine to log the user's request as a search query. In parallel (or otherwise in close time proximity), the requested URI is rendered in association with the user's computing device. In this way, search engines are able to use URIs bookmarked in association with a browser to gain knowledge regarding user webpage preferences and to utilize such shortcut navigation patterns in determining query share.

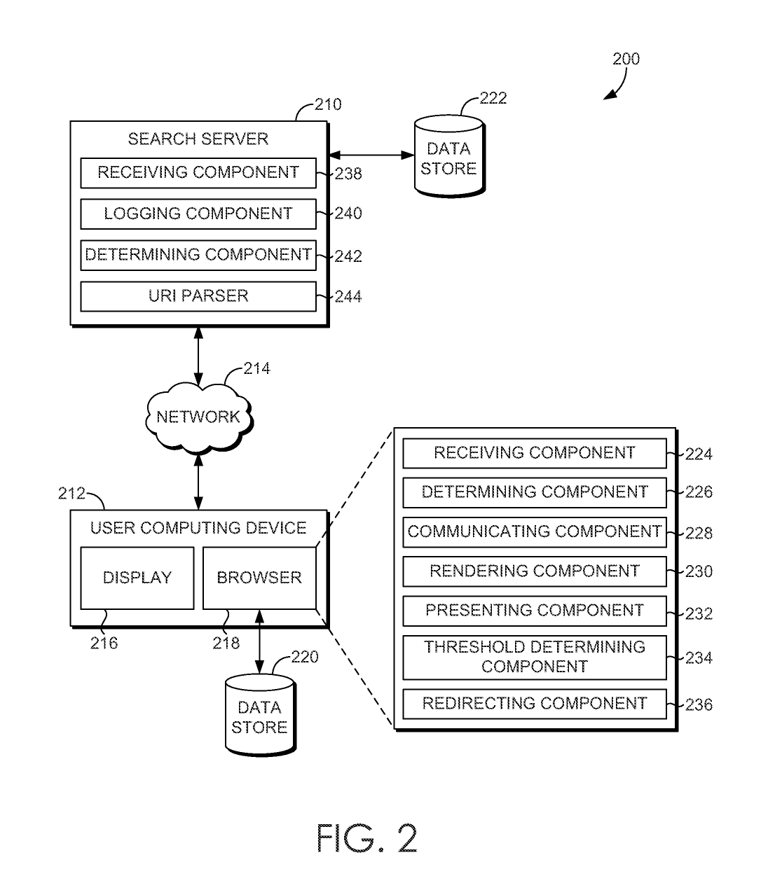

Referring now to FIG. 2, a block diagram is provided illustrating an exemplary computing system 200 in which embodiments of the present invention may be employed. Generally, the computing system 200 illustrates an environment in which search engines may be informed of requests for web pages bookmarked in association with a browser, and permitted to log such requests as search queries. Among other components not shown, the computing system 200 generally includes a search engine server 210 and a user computing device 212 in communication with one another via a network 214. The network 214 may include, without limitation, one or more local area networks (LANs) and/or wide area networks (WANs). Such networking environments are commonplace in offices, enterprise-wide computer networks, intranets and the Internet. Accordingly, the network 214 is not further described herein.

It should be understood that any number of search engine servers 210 and/or user computing devices 212 may be employed in the computing system 200 within the scope of embodiments of the present invention. Each may comprise a single device/interface or multiple devices/interfaces cooperating in a distributed environment. For instance, the search engine server 210 may comprise multiple devices and/or modules arranged in a distributed environment that collectively provide the functionality of the search engine server 210 described herein. Additionally, other components/modules not shown also may be included within the computing system 200.

In some embodiments, one or more of the illustrated components/modules may be implemented as stand-alone applications. In other embodiments, one or more of the illustrated components/modules may be implemented via the search engine server 210 and/or the user computing device 212. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of search engine servers 210 and/or user computing devices 212. By way of example only, the search engine server 210 might be provided as a single computing device (as shown), a cluster of computing devices, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The user computing device 210 may include any type of computing device, such as the computing device 100 described with reference to FIG. 1, for example. Generally, the user computing device 210 includes a display 216 and a browser 218. As more fully described below, the browser 218, among other things, is configured to render search engine home pages (or other online landing pages), and render SERPs in association with the display 216 of the user computing device 212. The browser 218 is further configured to receive user input of requests for various web pages (including search engine home pages), receive user inputted search queries (generally inputted via a user interface presented on the display 216 and permitting alpha-numeric and/or textual input into a designated search input area) and to receive content for presentation on the display 216, for instance, from the search engine server 210. It should be noted that the functionality described herein as being performed by the browser 218 may be performed by any other application capable of rendering Web content and having the functionality described herein. Any and all such variations, and any combination thereof, are contemplated to be within the scope of embodiments of the present invention.

As illustrated, the browser 218 includes a receiving component 224, a determining component 226, a communicating component 228, a rendering component 230, a presenting component 232, a threshold determining component 234 and a redirecting component 236. The illustrated browser 218 also has access to a data store 220. The data store 220 is configured to store information pertaining to bookmarked web pages. In various embodiments, such information may include, without limitation, a list of bookmarked URIs and user identifiers associated therewith. In embodiments, the data store 220 is configured to be searchable for one or more of the items stored in association therewith. It will be understood and appreciated by those of ordinary skill in the art that the information stored in association with the data store 220 may be configurable and may include any information relevant to URIs bookmarked in association with the browser 218. The content and volume of such information are not intended to limit the scope of embodiments of the present invention in any way. Further, though illustrated as a single, independent component, the data store 220 may, in fact, be a plurality of storage devices, for instance a database cluster, portions of which may reside in association with the user computing device 212, another external computing device (not shown), and/or any combination thereof.

The receiving component 224 of the browser 218 is configured to receive requests from users for URIs bookmarked in association with the browser. By way of example only, a user utilizing the search engine INTERNET EXPLORER provided by Microsoft Corporation of Redmond, Wash. may access a list of “favorites,” or webpage identifiers for web pages s/he has previously bookmarked for easy location and access, and select a webpage identifier representing a URI s/he desires to visit.

Upon the receiving component 224 receiving a request for a URI bookmarked in association with a browser (or as triggered by another appropriate user action), the determining component 226 of the browser 218 is configured to determine whether the user has a preferred search engine set as a default search engine and, if so, the identity of such default search engine. For instance, user computing devices running a WINDOWS operating system provided by Microsoft Corporation of Redmond, Wash. include a registry that stores configuration settings and options, including applications running on the platform. If a user has set a preferred search engine as a default search engine (e.g., the BING search engine provided by Microsoft Corporation of Redmond, Wash.), such preference is stored in association with the registry. The determining component 226 of the browser 218 is configured to access the registry (or other storage structure, as appropriate) and determine whether the user has set a preference for a default search engine and, if so, its identity.

If it is determined by the determining component 226 that the user has set a preferred search engine as a default search engine, the communicating component 228 of the browser 218 is configured to communicate the user's request for the bookmarked URI to a server associated with the default search engine. Such communication may be via transmission of an information packet containing the URI, an identity of the requesting user, and/or any other information deemed relevant to the transaction, via an Application Programming Interface (API), or any other means of communicating the desired information.

The rendering component 230 of the browser 218 is configured to render the requested bookmarked URI, for instance, on the display 216 of the user computing device 212. In embodiments, if the user is utilizing a tabbed browsing experience, such rendering may be in association with a different tab than the one from which the request for the bookmarked URI was received, or may be via a redirection of the tab from which the request for the bookmarked URI was received to the requested URI. Any and all such variations, and any combination thereof, are contemplated to be within the scope of embodiments of the present invention.

Implementation of embodiments of the present invention may be open and visible to the user or may be more subtle and undetectable to the user (e.g., not affect the user's experience in navigating to a requested bookmarked URI). If a more subtle implementation is desired, the relevant information may be communicated to the search engine “behind the scenes” such that the communication is unknown to the user. If, however, a more open and visible implementation is desired, the user may be notified that his or her request for the bookmarked URI has been communicated to the default search engine. In one embodiment, such notification may be provided via an announcement presented on the display (e.g., the display 216). Thus, the presenting component 232 of the browser 218 is configured to present such an announcement in association with the display of the requesting user's computing device (e.g., the display 216 of the user computing device 212).

In another embodiment, such notification may be provided by redirecting the user to a webpage associated with the default search engine upon receipt of the user's request (or otherwise rendering such webpage, e.g., in a different tab of a tabbed browsing experience). One such webpage may be, for instance, the default search engine's homepage. In embodiments, the bookmarked URI is presented in association with a search input area of the default search engine's webpage. Thus, the presenting component 232 of the browser 218 further is configured to present a webpage associated with the default search engine and to present a requested bookmarked URI in association with a search input area of the default search engine's presented webpage.

In embodiments in which a webpage associated with the default search engine is presented, the user may be permitted or required to take action (e.g., selecting an “enter” function) to have the requested URI presented subsequent to the default search engine's webpage, or the user may be directed to the requested URI without taking additional action. In embodiments in which the user does not take additional action to be navigated to the requested bookmarked URI, such navigation may automatically take place after a threshold period of time has passed. Thus, the threshold determining component 234 of the browser is configured to determine when a predetermined threshold period of time after a default search engine's webpage is presented has passed. The redirecting component 236 of the browser is configured to redirect the user to the requested bookmarked URI, for instance, after a threshold period of time has elapsed.

The search engine server 210 may include any type of computing device, such as the computing device 100 described with reference to FIG. 1, for example. As illustrated, the search engine server 210 includes a receiving component 238, a logging component 240, a determining component 242 and a URI parser 244. The illustrated search engine server 210 also has access to a data store 222. The data store 222 is configured to store information pertaining to search queries, search results, and data points associated therewith. In various embodiments, such information may include, without limitation, search query logs, search result identifying algorithms, user identifiers, and the like. In embodiments, the data store 222 is configured to be searchable for one or more of the items stored in association therewith. It will be understood and appreciated by those of ordinary skill in the art that the information stored in association with the data store 222 may be configurable and may include any information relevant to search queries, search results, and data points associated therewith. The content and volume of such information are not intended to limit the scope of embodiments of the present invention in any way. Further, though illustrated as a single, independent component, the data store 222 may, in fact, be a plurality of storage devices, for instance a database cluster, portions of which may reside in association with the search engine server 210, another external computing device (not shown), and/or any combination thereof.

The receiving component 238 of the search engine server 210 is configured to receive an indication that a particular user has requested a bookmarked URI. Typically, such a indication is received via a browser associated with a user computing device, for instance, the browser 218 associated with the user computing device 212. Such indication may be received via an information packet containing the URI, an identity of the requesting user, and/or any other information deemed relevant to the transaction, via an Application Programming Interface (API), or any other means of communicating the desired information.

The logging component 240 of the search engine server 210 is configured to log the user's request for the bookmarked URI as a search query, thus permitting use as a data resource for the search engine server 210.

The determining component 242 of the search engine server 210 is configured to determine that the received indication is indicative of a bookmarked URI, that is, the determining component 242 is configured to determine that the bookmarked URI is indeed a bookmarked URI. In embodiments, the determining component 242 is further configured to determine a user identifier associated with the bookmarked URI, for instance, an identifier associated with the user that bookmarked the URI and subsequently requested presentation thereof. Determining such information permits indexing of the bookmarked URI in association with the user identifier and/or an indication that the bookmarked URI is a bookmarked URI in association with a data store (e.g., data store 222), thus permitting utilization of such information as a data resource.

In embodiments, the browser 218 may hand-off responsibility for directing the user to the requested bookmarked URI to the search engine rather than maintaining responsibility for directing the user as requested. Thus, the search engine server 210 further may include a URI parser 244 that is configured to recognize a URI presented in association with a search input area of a webpage associated with the search engine as a URI. In this way, the search engine server 210 is able to redirect the user to the requested bookmarked URI rather than attempting to conduct a standard search utilizing the requested bookmarked URI as the search query. Any and all such variations, and any combination thereof, are contemplated to be within the scope of embodiments of the present invention.

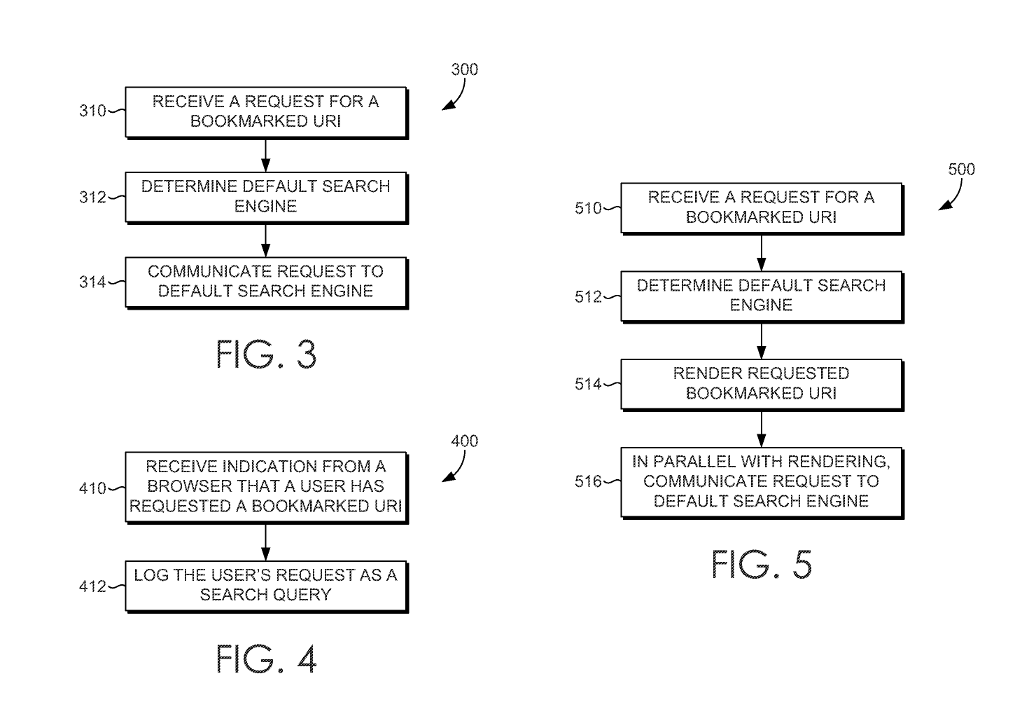

Turning now to FIG. 3, a flow diagram is illustrated showing an exemplary method 300 for communicating requests for web pages bookmarked in association with a browser to a search engine server, in accordance with an embodiment of the present invention. Initially, as shown at block 300, a request is received from a user for a URI that is bookmarked in association with a browser, for instance, the browser 218 of the user computing device 212 of FIG. 2. Whether the user has a default search engine associated with the user computing device (e.g., the user computing device 212 of FIG. 2) and, if so, what search engine is the user's default search engine is determined, as indicated at block 312. This may be done, for instance, utilizing the determining component 226 of the browser 218 of FIG. 2. As indicated at block 314, the user's request for the bookmarked URI is communicated to the determined default search engine, for instance, by the communicating component 228 of the browser 218 of FIG. 2.

With reference now to FIG. 4, a flow diagram is illustrated showing an exemplary method 400 for logging user requests for web pages bookmarked in association with a browser as search queries, in accordance with an embodiment of the present invention. As shown at block 410, an indication is received from a browser (e.g., the browser 218 of the user computing device 212 of FIG. 2) that a particular user has requested a bookmarked URI. Such an indication may be received, for instance, by the receiving component 238 of the search engine server 210 of FIG. 2. The user's request is then logged as a search query, as indicated at block 412. This may be done, for instance, utilizing the logging component 240 of the search engine server 210 of FIG. 2.

With reference to FIG. 5, a flow diagram is illustrated showing another exemplary method 500 for communicating requests for web pages bookmarked in association with a browser to a search engine server, in accordance with an embodiment of the present invention. Initially, as shown at block 500, a request is received from a user for a URI that is bookmarked in association with a browser, for instance, the browser 218 of the user computing device 212 of FIG. 2. Whether the user has a default search engine associated with the user computing device (e.g., the user computing device 212 of FIG. 2) and, if so, what search engine is the user's default search engine is determined, as indicated at block 512. This may be done, for instance, utilizing the determining component 226 of the browser 218 of FIG. 2. The requested bookmarked URI is rendered, for instance, on the display 216 of the user computing device 212 of FIG. 2. Such rendering may be done, e.g., utilizing the rendering component 230 of the browser 218 of FIG. 2. As indicated at block 516, in parallel with the rendering, the user's request for the bookmarked URI is communicated to the determined default search engine, for instance, by the communicating component 228 of the browser 218 of FIG. 2.

As can be understood, embodiments of the present invention provide systems, methods, and computer-readable storage media for, among other things, informing search engines of requests for web pages bookmarked in association with a browser, and permitting such requests to be logged by the search engines as search queries. The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the methods 300 of FIG. 3, 400 of FIGS. 4, and 500 of FIG. 5 is not meant to limit the scope of the present invention in any way and, in fact, the steps may occur in a variety of different sequences within embodiments hereof. Any and all such variations, and any combination thereof, are contemplated to be within the scope of embodiments of the present invention.

What is claimed is:

1. One or more computer-readable storage media storing computer-useable instructions that, when used by one or more computing devices, cause the one or more computing devices to perform a method comprising:
receiving a request from a user for a Uniform Resource Identifier (URI) bookmarked in association with a browser;
determining the user's default search engine is a particular search engine; and
communicating the user's request to the particular search engine.

2. The one or more computer-readable storage media of claim 1, wherein the method further comprises rendering the requested bookmarked URI.

3. The one or more computer-readable storage media of claim 1, wherein the method further comprises notifying the user that the user's request for the bookmarked URI has been communicated to the particular search engine.

4. The one or more computer-readable storage media of claim 3, wherein notifying the user that the user's request has been communicated to the particular search engine comprises redirecting the user to a webpage associated with the particular search engine upon receipt of the user's request, the webpage having a search input area.

5. The one or more computer-readable storage media of claim 4, wherein the method further comprises presenting the bookmarked URI in the search input area.

6. The one or more computer-readable storage media of claim 5, wherein the method further comprises:
determining that a threshold time period has passed subsequent to the presenting; and
redirecting the user to the bookmarked URI.

7. The one or more computer-readable storage media of claim 3, wherein notifying the user that the user's request has been communicated to the particular search engine comprises rendering a webpage associated with the particular search engine upon receipt of the user's request, the webpage having a search input area.

8. The one or more computer-readable storage media of claim 7, wherein the method further comprises presenting the bookmarked URI in the search input area.

9. The one or more computer-readable storage media of claim 8, wherein the method further comprises:
determining that a threshold time period has passed subsequent to the presenting; and
redirecting the user to the bookmarked URI.

10. One or more computer-readable storage media storing computer-useable instructions that, when used by one or more computing devices, cause the one or more computing devices to perform a method comprising:
receiving an indication from a browser that a particular user has requested a bookmarked Uniform Resource Identifier (URI); and
logging the user's request as a search query.

11. The one or more computer-readable storage media of claim 10, wherein the method further comprises determining that the bookmarked URI is a bookmarked URI.

12. The one or more computer-readable storage media of claim 11 wherein the method further comprises determining a user identifier associated with the bookmarked URI.

13. The one or more computer-readable storage media of claim 12, wherein logging the user's request as a search query comprises indexing the bookmarked URI in association with the user identifier and an indication that the bookmarked URI is a bookmarked URI.

14. The one or more computer-readable storage media of claim 11, wherein the method further comprises employing a URI parser allowing the particular search engine to recognize the input requested bookmarked URI as a URI.

15. A system comprising:
a browser associated with one or more processors and one or more computer-readable storage media; and
a data store coupled with the browser,
wherein the browser:
receives a request from a user for a Uniform Resource Identifier (URI) bookmarked in association with a browser;
determines the user's default search engine is a particular search engine;
renders the requested bookmarked URI; and
in parallel with the rendering, communicates the user's request to the particular search engine.

16. The system of claim 15, wherein the browser further notifies the user that the user's request for the bookmarked URI has been communicated to the particular search engine.

17. The system of claim 16, wherein the browser notifies the user that the user's request has been communicated to the particular search engine by rendering a webpage associated with the particular search engine upon receipt of the user's request, the webpage having a search input area.

18. The system of claim 17, wherein the browser renders a webpage associated with the particular search engine upon receipt of the user's request by redirecting the user to the webpage associated with the particular search engine upon receipt of the user's request.

19. The system of claim 17, wherein the browser further presents the bookmarked URI in the search input area.

20. The system of claim 19, wherein the browser further:
determines that a threshold time period has passed subsequent to the presenting; and
redirects the user to the bookmarked URI.
